(19) United States
(12) Patent Application Publication
(10) Pub. No.: US 2002/0116290 A1
(43) Pub. Date: Aug. 22, 2002

(54) System and method for providing a donor/donee matching service for the donation of intellectual property assets

(76) Inventor: Leslie C. Hodges, Livonia, MI (US)

Correspondence Address: LESLIE C. HODGES, General Motors Corporation, Mail Code 482-C23-B21, P.O. Box 300, Detroit, MI, 48265-3000, US

(21) Appl. No.: 10/078,135

(22) Filed: Feb. 19, 2002

Related U.S. Application Data
(60) Provisional application No. 60/270,082, filed on Feb. 20, 2001.

(51) Int. Cl. G06F 17/60

(52) U.S. Cl. 705/26

(57) ABSTRACT

A system and method for facilitating the donation of intellectual property assets (e.g., patents) from one or more potential or actual donors to one or more potential or actual donees.

This application claims priority from U.S. Provisional Application No. 60/270,082 filed Feb. 20, 2001.

### TECHNICAL FIELD

The present invention relates to electronic and non-electronic commerce, and more particularly to commerce that may be conducted on the World Wide Web.

### BACKGROUND OF THE INVENTION

Among the various assets owned or controlled by most businesses, universities, and the like are intellectual property (IP) assets, such as patents, trademarks, trade dress, domain names, copyrights, know how/trade secrets, and so forth. The owners of these IP assets typically use them for such purposes as: excluding others from making, using, or selling certain products or processes (as with patents); maintaining competitive advantage by keeping others from discovering the “secret recipe” behind a product or process (as with trade secrets/know how); promoting or enhancing product/producer recognition and trust in the minds of consumers (as with trademarks); and extracting royalties through the licensing of the asset to others.

One use of IP assets which has heretofore not been widely used is donation of the asset. By donating an IP asset, the donor can realize significant tax advantage from the donation, and the donee can typically accept donation of the asset for little or no cost. For example, as illustrated in FIG. 1, a corporation or other donor 10 might have a patent or other IP asset 30 relating to a technology which is not within its core area of competence and which the corporation does not wish to spend any further money on (for example, for such expenses as patent maintenance fees). If the corporation can donate the patent to a donee 20, such as a university or research consortium, then the corporation can free itself from further expense on the patent and realize a tax advantage on the donation, while the donee can take title to a “free” patent with perhaps the only potential expense being the payment of future maintenance fees. Owning the patent not only provides additional prestige to the donee, but may also permit it to practice in an area of research that it was previously excluded from, and to extract royalties from licensees under the patent. This exchange appears to represent a “win-win” situation for both the donor and donee. However, the exchange is not entirely without cost to the parties; it takes time, resources, and manpower (and sometimes the payment of money) in order for the donor to: search their assets for donation candidates, determine which assets to donate, determine who might be potential donees, contact the various people working for the potential donees in order to reach someone having decision-making authority regarding the potential donation, conduct (or contract with one or more third parties 40) for various valuation and/or other services (e.g., title searches, insurance, etc.), carry out the donation transaction, file all the necessary legal documents, etc. It would be desirable to find a way to minimize this effort in order to make the donation of IP assets much easier.

In recent years, various companies have established websites for facilitating the potential licensing of IP assets. For example, such companies as Yet2.com and The Patent & License Exchange, Inc. have established websites (http://www.yet2.com and http://www.pl-x.com, respectively) where potential licensors can list their patents as being available for licensing, and potential licensees can browse the sites and search for patents that they might be interested in licensing from the patent owners. (See, for example, PCT application WO 00/55791, which is incorporated herein by reference in its entirety.) However, no known website or other service exists where an IP asset owner can have the donation of its IP assets facilitated. Given the discussion above, it would be desirable to provide a website or other service which facilitates the donation of IP assets from potential donors to potential donees.

### SUMMARY OF THE INVENTION

The present invention overcomes the limitations of abovementioned prior art approaches by providing a system and method for facilitating the donation of IP assets from one or more potential or actual donors to one or more potential or actual donees.

A method according to the present invention may comprises the steps of: (a) providing a system for collecting information regarding the donor(s), donee(s) and IP asset(s); (b) collecting the donor, donee and IP asset information; (c) identifying potential matches among the donor, donee and IP asset information according to predetermined matching criteria; and (d) making the identified potential matches known to the potentially matching donor(s) and donee(s). Such a method may also include the steps of: (e) initiating one or more potential donation(s) of the identified IP asset(s) from the identified donor(s) to the identified donee(s); and (f) concluding one or more donation(s) of the identified IP asset(s) from the identified donor(s) to the identified donee(s), as well as conducting a valuation of the IP asset(s), and/or insuring the valuation, validity, and/or other aspect(s) of the IP asset(s).

Similarly, a system for carrying the present invention may comprise: (a) a service provider website connected to the World Wide Web/Internet; (b) a server supporting the website; (c) a database of donor, donee, and IP asset information; and (d) a control program for: (1) collecting, organizing, and updating the donor, donee, and IP asset information; (2) identifying potential matches among the donor, donee and IP asset information according to predetermined matching criteria; and (3) making the identified potential matches known to the potentially matching donor(s) and donee(s).

The system and method of the present invention provide user access to donors and donees (e.g., via the World Wide Web/Internet) for quickly and easily identifying, investigating, initiating, and concluding the donation of IP assets from donor(s) to donee(s), according to appropriate matching criteria, as further explained below.

### BRIEF DESCRIPTION OF THE DRAWINGS

FIG. 1 is a schematic illustrating an IP donation process according to the prior art.

FIG. 2 is a schematic illustrating an IP donation process according to the present invention.

FIG. 3 is a flowchart illustrating an IP donation process according to the present invention.

FIG. 4 is a schematic illustrating an IP donation computer system according to the present invention.

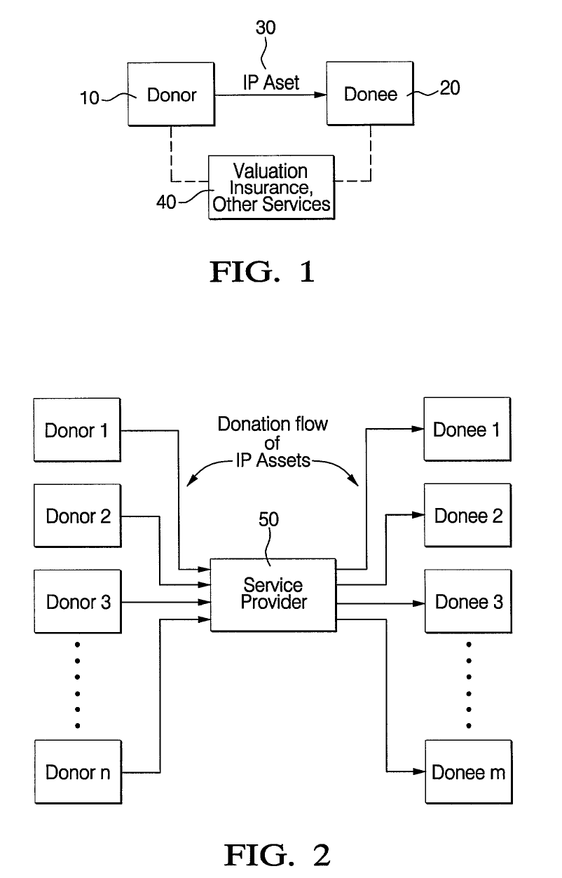

### DESCRIPTION OF THE PREFERRED EMBODIMENT

FIGS. 2-4 illustrate the system and method for facilitating the donation of IP assets from one or more potential or actual donors to one or more potential or actual donees according to the present invention. One aspect of the invention involves the use of one or more Service Providers (SPs) to facilitate the matching up of potential donors/donees/assets. The SP can provide its services via a computer network (e.g., via a website on the World Wide Web), via person-to-person contacts (e.g., phone calls, faxes, in-person visits), and so forth.

One advantage of the present invention is that the Service Provider can solicit potential donors and donees to join in or take advantage of the services it provides (perhaps on a paid or free subscription basis). The SP can not only passively accept potential donors/donees, but can proactively solicit potential donors/donees to join, perhaps based on the types of IP assets a given donor is thought to possess, or the types of IP assets a given donee is thought to have use for.

The SP (on its own and/or based on feedback/suggestions from donors/donees/etc.) may establish certain “matching criteria” which can be used to categorize/organize and match up the various donors/donees/assets. These matching criteria can include (but are not limited to): biographical information about the donor/donee (e.g., name, product lines, research areas typically focused on, areas of expertise, sales volume, number of patents owned, etc.), a description of the IP assets (including type, such as issued patent, published/unpublished patent application, trade secret, etc., as well as the identity of the asset, such as patent/serial number, country of filing/issuance, etc.) that are potentially or actually offered/desired/being considered for donation, the donation/donatability status of the asset (e.g., each asset could be identified as to how “ready for donation” it is (as viewed by the donor and/or the SP); e.g., “Ready to Donate”, “May Consider Donation”, “Need to Think About This One Further”, etc.), the types of technologies/applications/industries interested in, and so on. The SP and/or the donors/donees who use the service (e.g., via SP website) can use the matching criteria to determine when and where there are potential matches between one or more potential donors and one or more potential donees based on the criteria.

The SP may desire to set up one or more websites and appropriate processes/procedures/guidelines/rules/suggestions that donors/donees/ subscribers may follow for use of the service (e.g., rules/suggestions/strategies for using the SP matching service website).

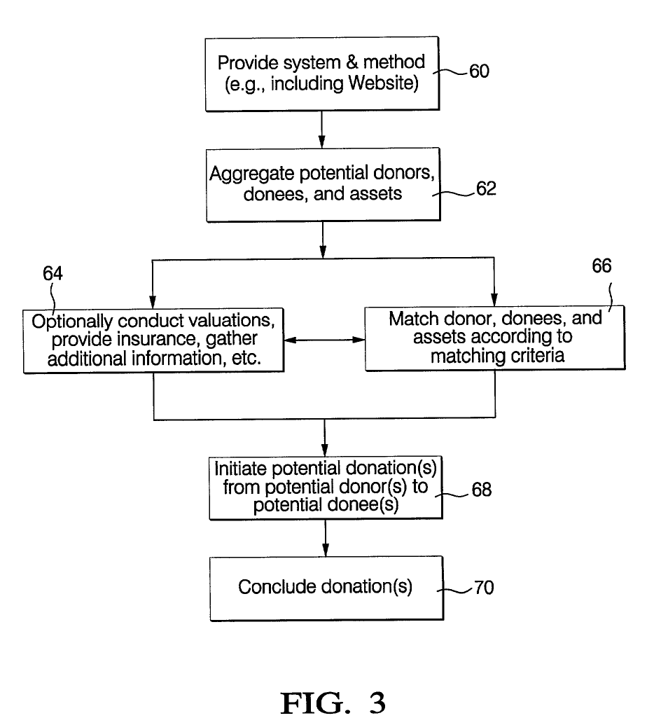

FIG. 3 illustrates one possible method/approach for the present invention. First [step 60], the SP sets up the service (e.g., set up holding company, install computer systems/infrastructure, set up website/web presence, conduct promotion/advertisement such as via magazines/search engines/banner ads/metatag associations/links, etc.) and its relevant support and infrastructure. Next or in conjunction with step 60 [step 62], the SP identifies/contacts/solicits/accepts potential donors/donees. This step can include subscribing donors/donees (“subscribers”) to the matching service via website, phone, fax, personal contacts, etc. This step may also include the SP soliciting/accepting information from donors/donees, and/or the donors/donees inputting information, about the types of technologies/assets they might consider donating or accepting, as well as other pertinent selection/matching criteria. The SP may periodically wish to review the database of assets, and optionally re-classify/re-categorize the assets, in order to detect/highlight/act on certain potential or actual trends/clusters/ matches among donors/donees/assets. Once donors/donees are given access to the system/service, they and/or the SP may then [step 66] begin seeking or discovering matches between donors and donees based on the matching criteria. For a web-based service, the assets (and possibly other data) could be keyword-searchable, selectable from a pick-list/drop-down list, etc. to facilitate the searching for and discovery of potential donation matches. The SP may include (e.g., as part of the system control software 86, described below) the use of various weighted and/or nonweighted schemes for identifying potential matches utilizing the selection criteria. Once potential matches are discovered, the SP may contact/prompt the donor/donee (e.g., via website, phone call, etc.), and/or the donor/donee may contact the SP and/or each other, according to any rules and guidelines the SP may have specified (and/or the donor/donee agreed to) regarding use of the site, confidentiality, etc.

In conjunction with step 66, there may be a need or desire for IP asset valuations, insurance underwriting, tax counseling, etc. [step 64], which may occur at any appropriate time before, during, and/or after step 66. This can be a service provided directly by the SP (e.g., such as using a Black-Scholes option pricing model such as that used in the Patent and License Exchange's TRUU Metrics™ valuation service), and/or contracted out to a third-party valuation/tax counseling firm (e.g., PriceWaterhouseCoopers), third-party underwriting firm (e.g., Swiss Re), etc.

Once potential matches are found according to the selection/matching criteria, potential donations may then be initiated [step 68]. If all goes well, a donation can be concluded quickly and easily [step 70] using this approach of the present invention. Steps 68 and/or 70 may include further steps for facilitating/concluding the transfer of the asset 30 (including title thereto) from the donor to the donee, such as handling/facilitating assignment papers, electronic signatures, governmental filings/recordations, escrow matters, etc.

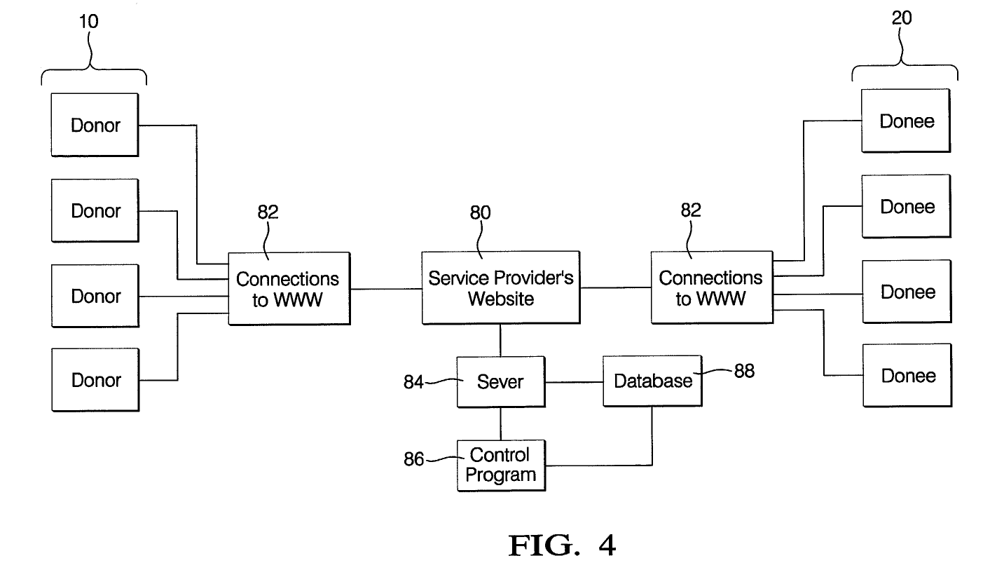

FIG. 4 illustrates a computer system for carrying out the present invention, such as on the World Wide Web (WWW). Potential donors 10 and donees 20 may access an on-line system according to the present invention via connections 82 to the WWW/Internet, connected in turn to the SP's website 80. This website 80 may in turn be operatively connected to or run by one or more servers 84 which contain or have access to one or more control programs 86 and or one or more databases 88. The control program(s), system software, etc., 86 noted in FIG. 4 may include program instructions that carry out the steps involved in the present invention that are described herein. The database(s) 88 may contain various donor, donee, asset, selection criteria, transactional, historical, and/or other relevant information useful to the control program(s) 86, and/or for carrying out or facilitating the donor/donee matching method of the present invention.

One consideration which may be important to donors/donees is confidentiality. For example, certain donors/donees may desire to keep their identities confidential until a certain point has been reached in a potential transaction. Also, it may be desirable to keep certain details of an asset confidential until a certain point has been reached in a potential transaction, such as keeping a particular patent number or certain portions of the patent confidential for a time.

The SP could check into the asset database 88 and determine which assets 30 (especially patents) have maintenance fees, annuities, or other fees coming due within a certain time (e.g., within the next 6 months). The SP could contact the donor 10 and alert them to this, so that donor can decide whether to plan on paying the fees or not. One factor which may influence the donor's decision is the extent to which any potential donee interest has been generated for the particular asset. The SP could also search through a database of assets of a potential donor which encompasses more than just the assets that the donor knows or suspects that it wants to donate. For example, the SP could arrange to load most or all of the IP assets of a subscriber/donor into a database, and then use search/selection criteria to determine which assets would be likely candidates for donation. These search/selection criteria could generate YES/NO or numerical or weighted responses to such questions/factors as: does (or how well does) the asset relate to the core competencies/technologies of the subscriber/donor, how much time/money/resources has already been spent on the development of the asset, how much would likely need to be spent if the asset were continued/maintained, what is the perceived value of the asset to the donor and/or to competitors/licensees/donees, what is the actual/objective/market value of the asset, how well does this asset relate to other assets owned by the donor, etc.

The SP could optionally charge a fee for these services it provides according to the present invention. Such fees could be a fixed or variable amount per asset once the asset is loaded into the database, a fixed or variable amount per asset once a donation transaction has been concluded, a pre-selected percentage of the asset value, an amount representing the amount of billable hours spent on the asset/transaction plus expenses, etc., or a combination of the above.

Optionally, the SP could arrange to have itself (or an associated or preselected third party) be the initial donee. (This third party could be a holding company, subsidiary, etc.) Then, the SP could find other parties to whom it could subsequently donate one or more assets. The SP could charge a fee to the donor covering the costs associated with valuing the asset, the transaction costs, etc. This fee could be sufficient to allow the SP to then donate (or license) the asset to yet another donee (or licensee, as the case may be). Some advantages to having the SP (or its associated or preselected third party) be the initial donee include: it allows the donor to quickly effect donation of an asset (i.e., the donor does not have to wait until an ultimate donee is found and convinced to accept the donation); the SP/third party initial donee can combine assets from multiple donors in order to offer a more diversified “cluster” or “portfolio” of assets to an ultimate donee than can be provided by any one single originating donor; etc. By clustering assets in this way, it is possible that the value of all the assets together is greater than the sum of their individual values, due to synergies and other portfolio effects. Also, it is more likely that a potential ultimate donee would accept a greater number of assets than a lesser number.

For example, a method according to the foregoing concept may comprise the steps of: (a) providing a system for collecting information regarding the donor(s), donee(s) and IP asset(s); (b) collecting the donor, donee and IP asset information; (c) identifying one or more IP asset(s) of one or more donor(s) as potential candidate(s) for donation to a “Donated IP Asset Holding Entity”; (d) completing a donation of the IP asset(s) from the donor(s) to the Donated IP Asset Holding Entity; and (e) licensing, selling, trading, or further donating the IP asset(s) by the Donated IP Asset Holding Entity to a third party.

The SP could optionally provide or purchase validity insurance and/or other insurances for selected assets, making the donation seem less risky and therefore more desirable to a potential donee. The cost for such insurance(s) could be funded through part of the fee charged to a donor, for example.

The SP could make the donor/donee matching service available to those who “subscribe” to or otherwise “sign up” for the service (with or without a fee), or could make it available to any party who logs onto the matching service website. The SP could also make the site accessible via search engines (e.g., Yahoo, MetaCrawler, etc.) to users who enter certain pre-selected keywords/metatags/etc., such as “donate”, “donation”, “donee”, “non-profit”, etc.

The donors/donees 10/20 referred to herein may include (without limitation): for-profit or not-for-profit organizations, colleges and universities, national laboratories, governmental agencies, research organizations, venture capital firms, start-ups, suppliers/competitors/customers to donors, etc. For example, a typical donor might be a corporation, a typical asset might be an issued patent owned by the donor corporation, and a typical donee might be a university having (or desiring to build) a program of study or certain research projects relating to the subject matter of the patent asset.

The system and method of the present invention may also optionally include a watch/alert service, to alert/notify potential donors/donees/SPs of potential matches based on the selection criteria as applied to IP assets newly added (or newly addable) to the asset database 88, such as newly issued patents and newly published patent applications. This watch/alert service could be fed via Internet newsfeeds, MAPIT/ DR-LINK (Manning & Napier), LEXIS/NEXIS, EDGAR, the USPTO Official Gazette, MicroPatent, etc.

Various other modifications and improvements to the present invention may occur to those skilled in the art to which the present invention pertains. Although not explicitly mentioned herein, such modifications may also be within the scope of the present invention. It is the following claims, including all equivalents, which define the scope of the present invention.

1. A method for facilitating the donation of one or more IP asset(s) from one or more potential or actual donor(s) to one or more potential or actual donee(s), said method comprising the steps of:
(a) providing a system for collecting information regarding the donor(s), donee(s) and IP asset(s);
(b) collecting the donor, donee and IP asset information;
(c) identifying potential matches among the donor, donee and IP asset information according to predetermined matching criteria; and
(d) making the identified potential matches known to the potentially matching donor(s) and donee(s).

2. A method according to claim 1, wherein step (a) includes providing a computer-based system utilizing the Internet for collecting information regarding the donor(s), donee(s) and IP asset(s).

3. A method according to claim 1, wherein step (b) includes having a service provider solicit and/or accept the information from the donor(s) and donee(s).

4. A method according to claim 1, wherein in step (c) the predetermined matching criteria include:
the type of each donor, donee, and/or IP asset;
the identity of the donor(s), donee(s), and/or IP asset(s);
the estimated value of the IP asset(s);
the industry(-ies) in which the donor(s) and/or donee(s) participate; and/or the technology(-ies) to which the IP asset(s) relate.

5. A method according to claim 1, wherein step (d) includes making the identified potential matches known to the potentially matching donor(s) and donee(s) by having a service provider contact and inform the potentially matching donor(s) and donee(s) of the potential match, and/or making information of such a potential match available to the potentially matching donor(s) and donee(s) via website.

6. A method according to claim 1, further comprising the step of:
(e) initiating one or more potential donation(s) of the identified IP asset(s) from the identified donor(s) to the identified donee(s).

7. A method according to claim 1, further comprising the step of:
(f) concluding one or more donation(s) of the identified IP asset(s) from the identified donor(s) to the identified donee(s).

8. A method according to claim 1, further comprising the step of conducting a valuation of the IP asset(s).

9. A method according to claim 1, further comprising the step of insuring the valuation, validity, and/or other aspect(s) of the IP asset(s).

10. A method for facilitating the donation of one or more IP asset(s) from one or more potential or actual donor(s) to one or more potential or actual donee(s), said method comprising the steps of:
(a) providing a system for collecting information regarding the donor(s), donee(s) and IP asset(s);
(b) collecting the donor, donee and IP asset information;
(c) identifying potential matches among the donor, donee and IP asset information according to predetermined matching criteria;
(d) making the identified potential matches known to the potentially matching donor(s) and donee(s);
(e) initiating one or more potential donation(s) of the identified IP asset(s) from the identified donor(s) to the identified donee(s); and
(f) concluding one or more donation(s) of the identified IP asset(s) from the identified donor(s) to the identified donee(s).

11. A computer-readable medium containing program instructions for:
(a) collecting and organizing information regarding one or more potential or actual donor(s), one or more potential or actual donee(s), and one or more IP asset(s) of the donor(s); and
(b) identifying potential matches among the donor, donee and IP asset information according to predetermined matching criteria.

12. A computer-readable medium according to claim 11, further including program instructions for:
(c) making the identified potential matches known to the potentially matching donor(s) and donee(s).

13. A computer-readable medium operatively coupled to a computer system for facilitating the donation of IP assets from one or more potential or actual donors to one or more potential or actual donees, the computer-readable medium containing program instructions for XYZ.
(a) collecting and organizing information regarding one or more potential or actual donor(s), one or more potential or actual donee(s), and one or more IP asset(s) of the donor(s);
(b) identifying potential matches among the donor, donee and IP asset information according to predetermined matching criteria; and
(c) making the identified potential matches known to the potentially matching donor(s) and donee(s).

14. An on-line website for facilitating the donation of IP assets from one or more potential or actual donors to one or more potential or actual donees, said site operative to carry out the steps of:
(a) collecting and organizing information regarding one or more potential or actual donor(s), one or more potential or actual donee(s), and one or more IP asset(s) of the donor(s);
(b) identifying potential matches among the donor, donee and IP asset information according to predetermined matching criteria; and
(c) making the identified potential matches known to the potentially matching donor(s) and donee(s).

15. A system for facilitating the donation of IP assets from one or more potential or actual donors to one or more potential or actual donees, said system comprising:
(a) a service provider website connected to the World Wide Web/Internet;
(b) a server supporting said website;
(c) a database of donor, donee, and IP asset information; and
(d) a control program for:
(1) collecting, organizing, and updating said donor, donee, and IP asset information;
(2) identifying potential matches among the donor, donee and IP asset information according to predetermined matching criteria; and
(3) making the identified potential matches known to the potentially matching donor(s) and donee(s).

16. A method for facilitating the donation of one or more IP asset(s) from one or more potential or actual donor(s) to one or more potential or actual donee(s), said method comprising the steps of:
(a) providing a system for collecting information regarding the donor(s), donee(s) and IP asset(s);
(b) collecting the donor, donee and IP asset information;
(c) identifying one or more IP asset(s) of one or more donor(s) as potential candidate(s) for donation to a Donated IP Asset Holding Entity;
(d) completing a donation of the IP asset(s) from the donor(s) to the Donated IP Asset Holding Entity; and
(e) licensing, selling, trading, or further donating the IP asset(s) by the Donated IP Asset Holding Entity to a third party.
